(19) United States
(12) Patent Application Publication
(10) Pub. No.: US 2026/0054396 A1
(43) Pub. Date: Feb. 26, 2026

(54) INDUSTRIAL ROBOT AND SYSTEM

(71) Applicant: ABB Schweiz AG, Baden (CH)

(72) Inventors: Tomas Botold, Västerås (SE); Johan Ernlund, Västerås (SE); Shanghua Li, Västerås (SE); Tommi Paananen, Västerås (SE)

(21) Appl. No.: 19/100,717

(22) PCT Filed: Aug. 15, 2022
(86) PCT No.: PCT/EP2022/072763

§ 371 Date: Feb. 3, 2025

(51) Int. Cl. B25J 19/00

(52) U.S. Cl. CPC B25J 19/0062

(57) ABSTRACT

An industrial robot having a plurality of joints; a plurality of links arranged to be driven in motion by the joints; a housing including the links, an opening and a cover for selectably closing the opening, the housing defining an interior region and an exterior region of the industrial robot; and for at least one joint, a kinematic device associated with the joint and positioned in the interior region, and at least one fluid connection in fluid communication with the kinematic device, each fluid connection being arranged to supply lubricant to, or to receive lubricant from, the kinematic device and being accessible from the exterior region through the opening when the cover is removed for connecting a service tool to the fluid connection. A system having an industrial robot and a service tool is also provided.

### TECHNICAL FIELD

The present disclosure generally relates to industrial robots. In particular, an industrial robot comprising a kinematic device containing lubricant, and a system comprising an industrial robot and a service tool, are provided.

### BACKGROUND

Industrial robots are widely used for various purposes. An industrial robot typically comprises a plurality of links and a plurality of joints between the links. By driving a joint, one link can move relative to another link. To this end, each joint typically comprises a gearbox and an electric motor arranged to drive the joint via the gearbox. Each set of electric motor and gearbox is often positioned externally with respect to a housing of the industrial robot. In these cases, the electric motor and the gearbox can easily be accessed, such as for maintenance.

Some industrial robots comprise electric motors and gearboxes inside the housing. This may for example be desired when the industrial robot operates in a hygienic environment where the industrial robot should not cause contaminations. Examples of such hygienic environments comprise processing environments for food, beverages or pharmaceuticals. In such hygienic environments, the industrial robot may also need to withstand harsh washdown environments. Also for this reason, it is advantageous if the electric motors and gearboxes are located inside the housing. Industrial robots comprising electric motors and gearboxes inside a housing are previously known.

JP H07246587 A discloses an industrial robot comprising a plurality of joints and a plurality of links forming a housing. A plurality of motors and a speed reducer are arranged inside the housing.

### SUMMARY

When an industrial robot comprises external gearboxes and other kinematic devices, these are easily accessible for oil exchange. However, for an industrial robot comprising gearboxes inside a housing, it is difficult to exchange the oil in the gearboxes. Today, the industrial robot needs to be disassembled to access the gearboxes for exchanging the oil therein. This procedure is very time consuming and difficult. With disassembly is meant that an electric connection and/or a mechanic chain through the industrial robot is broken such that the industrial robot is no longer operational. For example, at least one pair of links may be mechanically separated.

One object of the invention is to provide an improved industrial robot.

A further object of the invention is to provide an improved system comprising an industrial robot.

These objects are achieved by the industrial robot according to appended claim 1 and the system according to appended claim 10.

The invention is based on the realization that by providing one or more fluid connections in fluid communication with e.g. a gearbox behind a cover and inside a housing of an industrial robot, the fluid connections can easily be accessed to exchange oil in the gearbox when the cover is removed and the fluid connections can be hidden behind the cover when the cover is installed to provide a hygienic design of the housing.

According to a first aspect, there is provided an industrial robot comprising a plurality of joints; a plurality of links arranged to be driven in motion by the joints; a housing comprising the links, an opening and a cover for selectably closing the opening, the housing defining an interior region and an exterior region of the industrial robot; and for at least one joint, a kinematic device associated with the joint and positioned in the interior region, and at least one fluid connection in fluid communication with the kinematic device, each fluid connection being arranged to supply lubricant to, or to receive lubricant from, the kinematic device and being accessible from the exterior region through the opening when the cover is removed for connecting a service tool to the fluid connection.

Since each fluid connection is accessible through the opening, the industrial robot enables an efficient access to one or more interfaces associated with exchanging lubricant for one or more kinematic devices in the interior region. The efficient access can be enabled despite a plurality of kinematic devices are arranged tightly inside the housing. The principle of using the cover to both provide access to one or more fluid connections and to selectively provide an exterior seal of the housing enables a good hygienic design and an easy exchange of lubricant. The ease of exchanging lubricant is particularly valuable when using a food grade lubricant which may have to be exchanged more frequently than lubricants not compatible with food.

Each fluid connection may be associated with an opening in the housing. The opening may in turn be associated with a joint of the industrial robot. For each opening, the fluid connection may be in fluid communication with a kinematic device that may or may not be associated with the joint associated with the opening. In other words, kinematic devices of different joints can be accessed via fluid connections through a single opening.

Each fluid connection may be positioned less than 20 cm (centimeters), such as less than 10 cm, such as less than 5 cm, from the opening and/or from the cover when the cover closes the opening. In this way, each fluid connection is easily accessible from the exterior region through the opening when the cover is removed. A service tool, such as the service tool as described herein, can then be connected to each fluid connection exposed behind the cover for exchanging the lubricant in the kinematic device.

The industrial robot may comprise at least three programmable axes, such as six or seven programmable axes. The programmable axes may be provided in a serial manipulator.

Each link may be hollow. The cover may be configured to sealingly close the associated opening. The lubricant may be oil or grease. The lubricant may be classified as a food grade lubricant, such as a H1 lubricant, by National Science Foundation at the date of filing of this application.

The industrial robot may further comprise, for each fluid connection, a fluid line providing a fluid communication between the fluid connection and the kinematic device. One or more kinematic devices in the interior region may be equipped with one or more such fluid lines between the kinematic device and one or more fluid connections associated with the kinematic device.

Due to the provision of the one or more fluid lines, the industrial robot does not have to be designed such that each kinematic device can be reached by hand through an opening in the housing. Instead, it is sufficient if the one or more fluid lines are routed to the opening such that the one or more fluid connections can be reached, e.g. by hand. In this way, the one or more fluid lines enables a more compact design of the industrial robot.

Each fluid line may be configured such that the fluid connection can be positioned in the exterior region when the cover is removed. To this end, each fluid line may be flexible. Each fluid line may be provided with a slack when the fluid connection is positioned inside the closed cover. When the cover is removed and the one or more fluid connections are pulled out through the opening, the slack may be reduced or eliminated.

Each fluid line may comprise a hose.

The kinematic device may be a transmission, an electric motor, a bearing or a dynamic seal associated with the joint. The transmission may be a gearbox.

The housing may be hermetically sealed. In this way, the housing can withstand washdown processes. Thus, the cover may contribute to the hermetic sealing when closing the opening.

The industrial robot may comprise, for each fluid connection, a unique identification feature associated with the fluid connection and/or with the kinematic device. Each identification feature may be a machine readable identification feature, such as a visual code, such as a QR (quick response) code. The identification feature may contain information regarding a type of kinematic device associated with the fluid connection, a type of lubricant that should be used in the kinematic device associated with the fluid connection and/or an amount of lubricant that should be used in the kinematic device associated with the fluid connection.

The cover and the kinematic device may be positioned in opposite regions of a link associated with the joint with respect to an axis associated with the joint. For example, the cover and the kinematic device may be positioned on opposite sides of a geometric center point of the link along the axis.

The kinematic device may be positioned inside, and the opening may be provided in, a common link.

According to a second aspect, there is provided a system comprising an industrial robot according to the first aspect and a service tool. In this case, the service tool may be configured to be connected to one of the at least one fluid connection to supply lubricant to the kinematic device. The service tool may also be configured to be connected to another one of the at least one fluid connection to receive lubricant from the kinematic device. The service tool may also be configured to be connected to another one of the at least one fluid connection to evacuate air from the kinematic device.

The service tool may comprise a reader configured to identify the identification feature. The reader may be a machine code reader, such as a camera configured to recognize and extract information from the identification feature.

The service tool may comprise at least one service tool connection. Each service tool connection may be configured to be connected to a unique fluid connection associated with one of the joints. The service tool connections may comprise an input connection, an output connection and/or an air evacuation connection.

Each pair of a service tool connection and a fluid connection may form a quick coupling.

### BRIEF DESCRIPTION OF THE DRAWINGS

Further details, advantages and aspects of the present disclosure will become apparent from the following description taken in conjunction with the drawings, wherein:

FIG. 1: schematically represents a side view of a system comprising an industrial robot and a service tool;

FIG. 2: schematically represents a partial cross-sectional side view of the industrial robot when an opening is closed by a cover; and

FIG. 3: schematically represents a partial cross-sectional side view of the industrial robot when the cover is removed from the opening.

### DETAILED DESCRIPTION

In the following, an industrial robot comprising a kinematic device containing lubricant, and a system comprising an industrial robot and a service tool, will be described. The same or similar reference numerals will be used to denote the same or similar structural features.

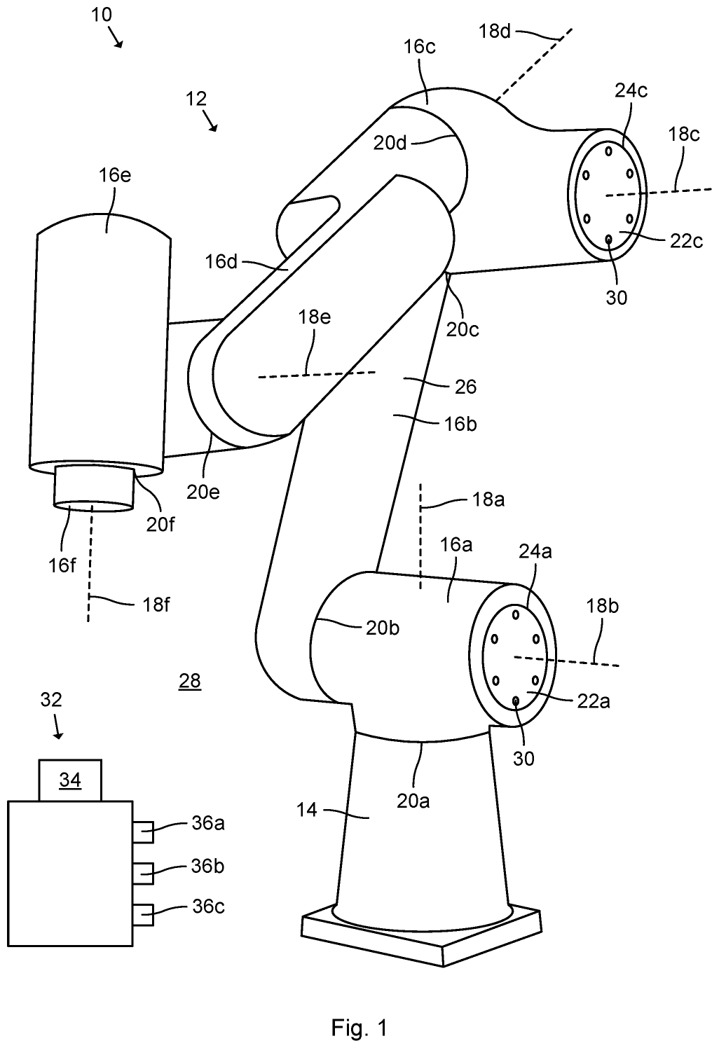

FIG. 1 schematically represents a side view of a system 10. The system 10 comprises an industrial robot 12. The industrial robot 12 of this example is a hygienic robot, e.g. for handling food, beverages and/or pharmaceuticals.

The industrial robot 12 of this specific and non-limiting example comprises a base 14, a first link 16a rotatable relative to the base 14 about a first axis 18a at a first joint 20a, a second link 16b rotatable relative to the first link 16a about a second axis 18b at a second joint 20b, a third link 16c rotatable relative to the second link 16b about a third axis 18c at a third joint 20c, a fourth link 16d rotatable relative to the third link 16c about a fourth axis 18d at a fourth joint 20d, a fifth link 16e rotatable relative to the fourth link 16d about a fifth axis 18e at a fifth joint 20e, and a sixth link 16f rotatable relative to the fifth link 16e about a sixth axis 18f at a sixth joint 20f. The industrial robot 12 of this example is thus a serial six-axis manipulator. The base 14 may be fixed to an external surface, such as a floor. An end effector (not shown) may be connected to the sixth link 16f.

Each link 16a-16f may also be referred to with reference numeral “16”. Each axis 18a-18f may also be referred to with reference numeral “18”. Each joint 20a-20f may also be referred to with reference numeral “20”.

The industrial robot 12 further comprises a plurality of covers and a plurality of openings. FIG. 1 shows a first cover 22a associated with the first link 16a that sealingly closes a first opening 24a in the first link 16a, and a third cover 22c associated with the third link 16c that sealingly closes a third opening 24c in the third link 16c. Each cover may also be referred to with reference numeral “22”. Each opening may also be referred to with reference numeral “24”.

In this example, the base 14, the links 16, and the covers 22 form a housing 26 of the industrial robot 12. The housing 26 here forms a hermetic seal between an exterior region 28 outside the housing 26 and an interior region inside the housing 26. Thus, when all covers 22 are closed, water and air are prevented from entering the inside of the housing 26 and vice versa.

Each cover 22 can be selectively removed from its associated opening 24, here by removing bolts 30. When a cover 22 is removed, the interior of the housing 26 can be accessed. The hermetic seal is however broken when the cover 22 is removed.

Each link 16 may be made of stainless steel. Also each cover 22 may be made of stainless steel.

The system 10 further comprises a service tool 32. The service tool 32 of this specific and non-limiting example comprises a reader 34, an input connection 36a, an output connection 36b and an air evacuation connection 36c. The input connection 36a, the output connection 36b and the air evacuation connection 36c constitute examples of service tool connections according to the present disclosure.

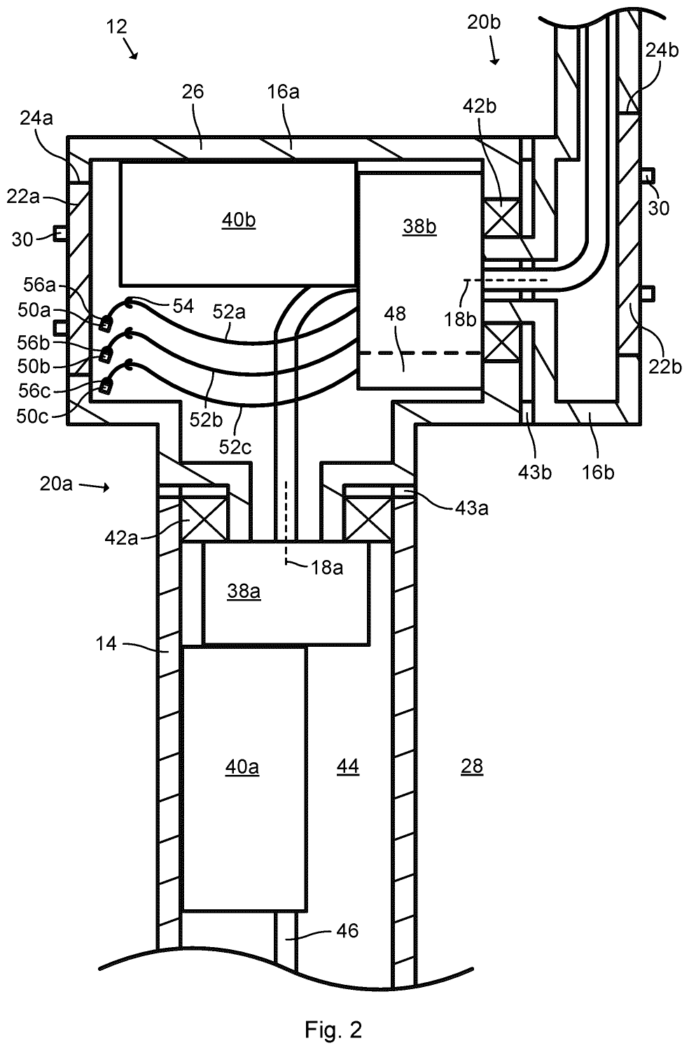

FIG. 2 schematically represents a partial cross-sectional side view of the industrial robot 12. In FIG. 2, the first opening 24a is closed by the first cover 22a.

The first joint 20a comprises a first gearbox 38a and a first electric motor 40a arranged to drive the first link 16a via the first gearbox 38a. The first joint 20a further comprises a first bearing 42a for rotationally supporting the first link 16a about the first axis 18a. The first gearbox 38a and the first electric motor 40a are positioned inside the base 14. The first joint 20a further comprises a first dynamic seal 43a configured to seal between the base 14 and the first link 16a.

Correspondingly, the second joint 20b comprises a second gearbox 38b and a second electric motor 40b arranged to drive the second link 16b via the second gearbox 38b. The second joint 20b further comprises a second bearing 42b for rotationally supporting the second link 16b about the second axis 18b. The second gearbox 38b and the second electric motor 40b are positioned inside the first link 16a. The second joint 20b further comprises a second dynamic seal 43b configured to seal between the first link 16a and the second link 16b.

Each gearbox 38a and 38b may also be referred to with reference numeral “38”. Each electric motor 40a and 40b may also be referred to with reference numeral “40”. Each bearing 42a and 42b may also be referred to with reference numeral “42”. Each dynamic seal 43a and 43b may also be referred to with reference numeral “43”.

In the same way as described for the first joint 20a and the second joint 20b, each remaining joint 20c-20f of the industrial robot 12 may comprise a corresponding gearbox 38, electric motor 40 and bearing 42. In this way, each joint 20 can drive an associated link 16.

Each gearbox 38 is an example of a transmission according to the present disclosure. The gearboxes 38, the electric motors 40, the bearings 42 and the dynamic seals 43 are examples of kinematic devices according to the present disclosure.

In FIG. 2, the interior region 44 can be seen. The housing 26 thus defines the interior region 44 and the exterior region 28. As shown, each gearbox 38, each electric motor 40 and each bearing 42 is positioned in the interior region 44. FIG. 2 also shows a second cover 22b associated with the second link 16b that seals a second opening 24b in the second link 16b.

FIG. 2 further shows that the industrial robot 12 comprises a cable harness 46. The cable harness 46 is routed in the interior region 44 from the base 14 to the sixth link 16f. One or more cables, such as power and control cables, may branch off from the cable harness 46 at each joint 20, e.g. for powering and controlling the electric motor 40 of the joint 20.

FIG. 2 schematically shows that the second gearbox 38b contains oil 48, which is one example of lubricant according to the present disclosure. Although oil exchange will be described in connection with the second gearbox 38b, the oil exchange can be performed in a corresponding manner for any of the other gearboxes 38, any of the electric motors 40 and/or any of the bearings 42.

The industrial robot 12 of this example comprises a first fluid connection 50a, a second fluid connection 50b and a third fluid connection 50c. Each fluid connection 50a-50c may also be referred to with reference numeral “50”. Each fluid connection 50 is in fluid communication with the second gearbox 38b. As shown, the fluid connections 50 are positioned just behind the first cover 22a, such as less than 5 cm from the first cover 22a. In this example, the fluid connections 50 are positioned at one side inside the first link 16a along the second axis 18b and the second gearbox 38b is positioned at an opposite side inside the first link 16a along the second axis 18b.

The industrial robot 12 of this example further comprises a first hose 52a establishing a fluid communication between the first fluid connection 50a and the second gearbox 38b, a second hose 52b establishing a fluid communication between the second fluid connection 50b and the second gearbox 38b, and a third hose 52c establishing a fluid communication between the third fluid connection 50c and the second gearbox 38b. The first fluid connection 50a is configured to supply oil 48 to the second gearbox 38b via the first hose 52a. The second fluid connection 50b is configured to receive oil 48 from the second gearbox 38b. The third fluid connection 50c is configured to evacuate air from the second gearbox 38b via the third hose 52c.

Each hose 52a-52c may also be referred to with reference numeral “52”. Each hose 52 is one example of a fluid line according to the present disclosure. As shown in FIG. 2, each hose 52 is flexible and is here secured to the first link 16a by a respective hook 54.

As shown in FIG. 2, the industrial robot 12 comprises a first identification feature 56a connected to, and associated with, the first fluid connection 50a, a second identification feature 56b connected to, and associated with, the second fluid connection 50b, and a third identification feature 56c connected to, and associated with, the third fluid connection 50c. Each identification feature 56a-56c may also be referred to with reference numeral “56”.

Each identification feature 56 is here exemplified as a QR code. Each identification feature 56 contains information associated with exchange of oil 48.

When the first cover 22a closes the first opening 24a, the housing 26 has a relatively smooth exterior profile. For example, no visible oil plugs are provided at the exterior of the housing 26.

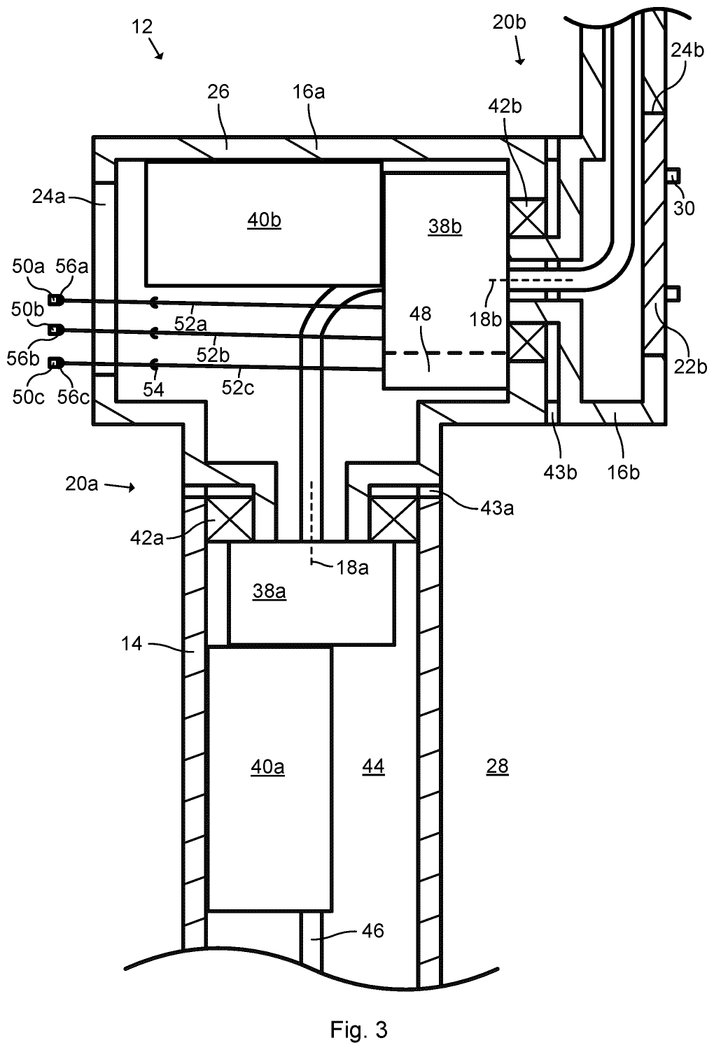

FIG. 3 schematically represents a partial cross-sectional side view of the industrial robot 12. In FIG. 3, the first cover 22a has been removed from the first opening 24a. When the first cover 22a is removed, the fluid connections 50 are exposed just within the first opening 24a. Due to the slack in the hoses 52, a user can also pull the fluid connections 50 through the first opening 24a such that the fluid connections 50 are positioned in the exterior region 28 outside the industrial robot 12. Regardless of the slack in the hoses 52, the fluid connections 50 are accessible from the exterior region 28 through the first opening 24a when the first cover 22a is removed for connecting the service tool 32.

By means of the reader 34, image data of the identification features 56 can be obtained to extract various information. The first identification feature 56a, the second identification feature 56b and the third identification feature 56c contain information indicating that the input connection 36a, the output connection 36b and the air evacuation connection 36c should be respectively connected thereto, e.g. by quick couplings. One, several or all of the identification features 56 may contain information regarding a type of oil 48 to be used in the second gearbox 38b, and/or an amount of oil 48 to be used in the second gearbox 38b.

A user can thus remove the first cover 22a from the first opening 24a, pull out the fluid connections 50 to the exterior region 28, read the identification features 56 by the reader 34, connect the service tool 32 and exchange the oil 48 in accordance with the information from the identification features 56. For example, the information from the identification features 56 ensures that the right oil 48 and the right amount of oil 48 are used. The service tool 32 may for example be configured to only perform oil exchange in accordance with the obtained information from the identification features 56. In this way, it becomes impossible to supply an incorrect oil 48 or an incorrect amount of oil 48.

When the oil 48 has been exchanged, the service tool 32 is disconnected, the fluid connections 50 are inserted into the interior region 44 and the first cover 22a is put back to sealingly close the first opening 24a. Information related to the oil exchange, such as time and condition of the oil 48, can be registered in a control system (not shown).

The fluid connections 50, the openings 24 and the covers 22 enable an efficient oil exchange without compromising the hygienic design of the industrial robot 12 and despite very narrow spaces inside the industrial robot 12. The identification features 56 also contribute to greatly facilitating oil exchange and ensuring that the oil 48 is exchanged in a controlled manner, e.g. by minimizing a risk that an incorrect oil 48 is introduced.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. An industrial robot comprising:
a plurality of joints;
a plurality of links arranged to be driven in motion by the joints;
a housing including the links an opening and a cover for selectably closing the opening, the housing defining an interior region and an exterior region of the industrial robot; and
for at least one joint, a kinematic device associated with the joint and positioned in the interior region and at least one fluid connection in fluid communication with the kinematic device, each fluid connection being arranged to supply lubricant to, or to receive lubricant from, the kinematic device and being accessible from the exterior region through the opening when the cover is removed for connecting a service toolto the fluid connection.

2. The industrial robot according to claim 1, further comprising, for each fluid connection a fluid line providing a fluid communication between the fluid connection and the kinematic device.

3. The industrial robot according to claim 2, wherein each fluid line is configured such that the fluid connection can be positioned in the exterior region when the cover is removed.

4. The industrial robot according to claim 2, wherein each fluid line comprises a hose.

5. The industrial robot according to claim 1, wherein the kinematic device is a transmission, an electric motor, a bearing or a dynamic sea associated with the joint.

6. The industrial robot according to claim 1, wherein the housing is hermetically sealed.

7. The industrial robot according to claim 1, wherein the industrial robot comprises, for each fluid connection, a unique identification feature associated with the fluid connection and/or with the kinematic device.

8. The industrial robot according to claim 1, wherein the cover and the kinematic device are positioned in opposite regions of a link associated with the joint with respect to an axis associated with the joint.

9. The industrial robot according to claim 1, wherein the kinematic device is positioned inside, and the opening is provided in, a common link.

10. A system comprising an industrial robot having
a plurality of joints;
a plurality of links arrange drive in motion by the joints;
a housing including the links, an opening and a cover for selectably closing the opening the housing defining an interior region and an exterior region of the ind strial robot; and
for at least one joint, a kinematic device associated with the joint and positioned in the interior region, and at least one fluid connection in fluid communication with the kinematic device, each fluid connection being ar to supply lubricant to, or to receive lubricant from, the kinematic device and being accesible from the exterior region through the opening when the cover is removed for connecting a service tool to the fluid connection and a service tool, wherein the service toolis configured to be connected to one of the at least one fluid connection to supply lubricant to the kinematic device.

11. The system according to claim 10, when comprising an industrial robot, wherein the service tool comprises a reader configured to identify the identification feature.

12. The system according to claim 10, wherein the service toolcomprises at least one service tool connection, each service tool connection being configured to be connected to a unique fluid connection associated with one of the joints.

13. The system according to claim 12, wherein each pair of a service tool connection and a fluid connection forms a quick coupling.

14. The industrial robot according to claim 3, wherein each fluid line comprises a hose.

15. The industrial robot according to claim 2, wherein the kinematic device is a transmission, an electric motor, a bearing or a dynamic seal associated with the joint.

16. The industrial robot according to claim 2, wherein the housing is hermetically sealed.

17. The industrial robot according to claim 2, wherein the industrial robot comprises, for each fluid connection, a unique identification feature associated with the fluid connection and/or with the kinematic device.

18. The industrial robot according to claim 2, wherein the cover and the kinematic device are positioned in opposite regions of a link associated with the joint with respect to an axis associated with the joint.

19. The industrial robot according to claim 2, wherein the kinematic device is positioned inside, and the opening is provided in, a common link.
